(19) United States
(12) Patent Application Publication
(10) Pub. No.: US 2019/0178149 A1
(43) Pub. Date: Jun. 13, 2019

(54) ENERGY SUPERCHARGER SYSTEM AND METHOD

(71) Applicant: Caterpillar Inc., Peoria, IL (US)

(72) Inventors: Eric L. Schroeder, Germantown Hills, IL (US); Ryan T. Sunley, Washington, IL (US)

(73) Assignee: Caterpillar Inc., Peoria, IL (US)

(21) Appl. No.: 15/839,145

(22) Filed: Dec. 12, 2017

(51) Int. Cl. F02B 37/16; F02B 37/10; F02B 37/20

(52) U.S. Cl. CPC F02B 37/168; F02B 39/10; F02B 37/20; F02B 37/10

(57) ABSTRACT

A supercharger system for an engine having a turbocharger is provided. The supercharger system includes a supercharger driver and an air inlet. The supercharger system also includes a supercharger compressor mechanically coupled to the supercharger driver. The supercharger compressor includes a supercharger compressor inlet and a supercharger compressor outlet. The supercharger compressor inlet is in fluid communication with the air inlet. The supercharger compressor outlet is in fluid communication with a turbine inlet associated with the turbocharger.

### TECHNICAL FIELD

The present disclosure generally relates to a supercharger system and a method for operating an internal combustion engine. More particularly, the present disclosure relates to a supercharger system and a method for improved engine transient response.

### BACKGROUND

Generally, a turbocharger is employed on an engine for increasing a pressure of intake air (boost) entering combustion chambers of the engine. The turbocharger may be typically driven by a stream of exhaust gases exiting the combustion chambers of the engine. When the engine is operating on a low load, the turbocharger may not be able to provide a desired pressure to the intake air to meet any sudden load applied on the engine.

In some applications, the engine may be used to drive an electrical generator. When a sudden electrical load is applied on the generator, the engine may be required to quickly ramp up a speed of the engine, so that the generator output meets a minimum frequency and′ voltage requirements associated with the electrical load. However, the turbocharger associated with the engine may not be able to provide enough pressure to the intake air for combustion of a required amount of fuel to quickly increase the speed of the engine.

U.S. Pat. No. 9,228,487 (hereinafter referred to as “the '487 patent”) describes an engine having a turbocharger and a supercharger. The '487 patent discloses that compressed air from the supercharger is being fed to a suction side (i.e. air inlet side) of a compressor associated with the turbocharger in order to meet a sudden increase in load demand on the engine. However, in this kind of arrangement, for the supercharger to provide a boost pressure equivalent to that of the turbocharger running at high speeds may require higher capacity superchargers, requiring larger space and higher cost.

### SUMMARY OF THE DISCLOSURE

In one aspect of the present disclosure, a supercharger system for an engine having a turbocharger is provided. The supercharger system includes a supercharger driver and an air inlet. The supercharger system also includes a supercharger compressor mechanically coupled to the supercharger driver. The supercharger compressor includes a supercharger compressor inlet and a supercharger compressor outlet. The supercharger compressor inlet is in fluid communication with the air inlet. The supercharger compressor outlet is in fluid communication with a turbocharger turbine inlet.

In another aspect of the present disclosure, an engine is provided. The engine includes a plurality of combustion chambers. Each of the plurality of combustion chambers is in fluid communication with an air intake manifold and an exhaust manifold of the engine. The engine also includes a turbocharger having a turbocharger turbine. The turbocharger turbine includes a turbocharger turbine inlet in fluid communication with the exhaust manifold of the engine. The engine further includes a supercharger system. The supercharger system includes a supercharger driver and an air inlet. The supercharger system also includes a supercharger compressor mechanically coupled to the supercharger driver. The supercharger compressor includes a supercharger compressor inlet and a supercharger compressor outlet. The supercharger compressor inlet is in fluid communication with the air inlet. The supercharger compressor outlet is in fluid communication with the turbocharger turbine inlet.

A method is provided for operating an engine having a turbocharger and a supercharger and the engine is coupled to a generator. The method includes determining, by means of a controller, whether an intake air pressure or intake air flow rate of an air intake manifold is below a threshold, when the engine is running at low load. The method includes driving a supercharger compressor. The method includes receiving a flow of ambient air into the supercharger compressor. The method further includes pressurizing the received ambient air by the supercharger compressor. The method further includes providing pressurized air from the supercharger compressor to an exhaust manifold of the engine to provide a flow of pressurized air to turbocharger turbine inlet. The method further includes sensing, by means of a controller, a sudden additional load on the engine. The method includes increasing an amount of fuel into a plurality of the combustion chambers of the engine.

Other features and aspects of this disclosure will be apparent from the following description and the accompanying drawings.

### BRIEF DESCRIPTION OF THE DRAWINGS

The features and advantages of the present disclosure will become more apparent from the detailed description set forth below when taken in conjunction with the drawings.

FIG. 1 is a schematic illustration of an engine having a turbocharger and a supercharger system, according to an aspect of the present disclosure; and

FIG. 2 is a flowchart depicting a method for operating the supercharger system of the engine, according to an aspect of the present disclosure.

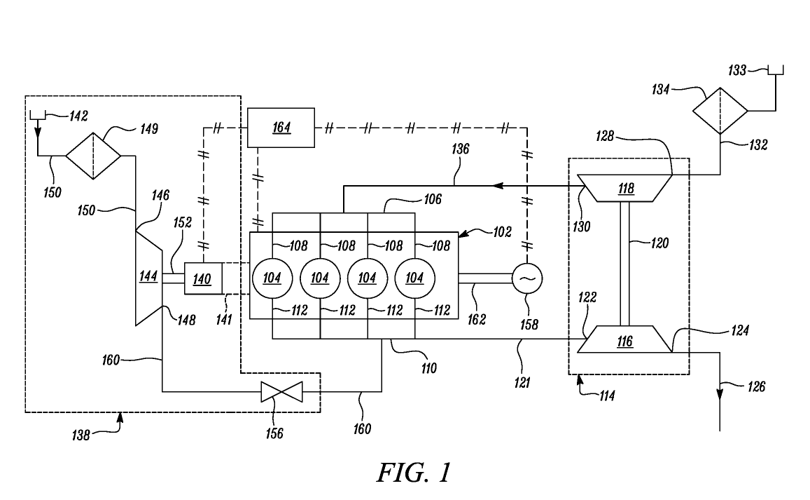

### DETAILED DESCRIPTION

Wherever possible, the same reference numbers will be used throughout the drawings to refer to same or like parts. FIG. 1 illustrates an engine 102 according to an embodiment of the present disclosure. As shown, the engine 102 includes multiple combustion chambers 104. In the illustrated embodiment of FIG. 1, the engine 102 has four combustion chambers 104. However, in other embodiments, the engine 102 may be configured to include fewer or more combustion chambers 104.

As shown in FIG. 1, the engine 102 may be provided with an air intake manifold 106 being in fluid communication with each of the combustion chambers 104 by a supply tube 108 corresponding to each of the combustion chambers 104. The air intake manifold 106 may be configured to receive a supply of air or a premixed charge that may be operatively supplied to each of the combustion chambers 104 via the corresponding supply tube 108. The engine 102 may also be provided with an exhaust manifold 110 being in fluid communication with the combustion chambers 104 by an exhaust tube 112 corresponding to each of the combustion chambers 104. The exhaust manifold 110 may be configured to receive a stream of exhaust gases from each of the combustion chambers 104 via the corresponding exhaust tube 112.

The engine 102 further includes a turbocharger 114 that is fluidly coupled to the engine 102. The turbocharger 114 includes a turbocharger turbine 116 and a turbocharger compressor 118 mechanically coupled to the turbocharger turbine 116 through a connecting shaft 120. The turbocharger turbine 116 includes a turbocharger turbine inlet 122 and a turbocharger turbine outlet 124. The turbocharger turbine inlet 122 is in fluid communication with the exhaust manifold 110 of the engine 102 via an exhaust inlet line 121. The turbocharger turbine outlet 124 may be fluidly coupled with an exhaust outlet line 126, which may direct exhaust gases to an aftertreatment module, muffler exhaust stack, or other components (not shown). Further, in an embodiment, the engine 102 may include multiple turbochargers such as turbochargers 114. Also, the exhaust manifold 110 may be divided into multiple sections (not shown), fluidly coupled with the turbocharger turbine inlet 122.

The turbocharger compressor 118 includes a turbocharger compressor inlet 128 and a turbocharger compressor outlet 130. The turbocharger compressor inlet 128 is fluidly coupled to an air intake line 132 (hereinafter referred to as “the first air intake line”). The first air intake line 132 is configured to receive a flow of ambient air from an air inlet 133 in fluid communication with an ambient air source. As shown in the illustrated embodiment of FIG. 1, a first filter 134 may be placed in the first air intake line 132 to filter contaminants, such as particulates, from the ambient air before it flows into the turbocharger compressor 118.

Further as shown in the illustrated embodiment of FIG. 1, the turbocharger compressor outlet 130 is fluidly coupled to the air intake manifold 106 via an outlet line 136. In an embodiment, the engine 102 may also be associated with other components including, but not limited to, an aftercooler, a gas admission valve, or an air throttle valve that may be in fluid communication with the outlet line 136.

The engine 102 may also include a supercharger system 138. The supercharger system 138 includes a supercharger driver 140, and a supercharger compressor 144 mechanically coupled to the supercharger driver 140. In the illustrated embodiment of FIG. 1, the supercharger driver 140 may be driven by any auxiliary power source including, but not limited to, an electric motor or a hydraulic motor. In another embodiment, the supercharger driver 140 may include a mechanical coupling 141 (shown in dotted line in FIG. 1) between an engine output and the supercharger compressor 144, such as a belt drive system, a chain drive system or a gear drive system.

The supercharger compressor 144 includes a supercharger compressor inlet 146 and a supercharger compressor outlet 148. The supercharger compressor inlet 146 is in fluid communication with an air inlet 142 of the supercharger system 138. As shown in the illustrated embodiment of FIG. 1, the supercharger compressor inlet 146 may be in fluid communication with the air inlet 142 in fluid communication with an ambient air source via an air intake line 150 (hereinafter referred to as “the second air intake line”). The supercharger system 138 may also include a second air filter 149 in fluid communication with the second air intake line 150 and located between the air inlet 142 and the supercharger compressor inlet 146. The second air filter 149 filters any contaminants from the ambient air before it flows into the supercharger compressor 144 via the supercharger compressor inlet 146. Although not shown in FIG. 1, it should be apparent that the first air intake line 132 and the second air intake line 150 are in fluid communication with the same ambient air source and may alternatively configured as branches of a single intake air line fluidly coupled to a single air inlet.

The supercharger compressor outlet 148 may be in fluid communication with the exhaust manifold 110 of the engine 102. As shown in the illustrated embodiment of FIG. 1, the supercharger compressor outlet 148 may be fluidly coupled to the exhaust manifold 110 of the engine 102 via an outlet line 160. In an embodiment, in which the exhaust manifold 110 may include multiple sections, the supercharger compressor outlet 148 may be fluidly coupled to any one or more section of the exhaust manifold 110 via the outlet line 160. Also, as shown in the FIG. 1, the exhaust manifold 110 is in fluid communication with the turbocharger turbine inlet 122 via an exhaust inlet line 121. Thus, the supercharger compressor outlet 148 is in fluid communication with the turbine inlet 122 via the exhaust manifold 110.

In the embodiment shown in FIG. 1, the supercharger system 138 may include a shut off valve 156 positioned in the outlet line 160. The shut off valve 156 may be configured to open based on a pressure of the pressurized air in the outline line 160. Thus, the shut off valve 156 remains open during an operation of the supercharger system 138 and closes when the supercharger system 138 is not in operation.

The engine 102 may be configured to operatively drive a load, for example, an electrical generator 158 as shown in FIG. 1. The engine 102 may be mechanically coupled to the generator 158 by an output shaft and may be driven by the engine 102 to convert mechanical energy output from the engine 102 into electrical energy.

As shown in the FIG. 1, there may be a controller 164 communicably coupled to the engine 102, the generator 158, the supercharger driver 140, the shut off valve 156 and fuel injectors (not shown) for supplying the fuel to each of the combustion chambers 104. In an embodiment, if the engine 102 is running at low load the controller 164 may determine, by means of one or more sensors (not shown), whether an intake air pressure in the air intake manifold 106, a flow of intake air in the intake manifold 106, or a speed of the turbocharger turbine 116 is below a threshold that may not enable the controller 164 to increase an amount of fuel to be supplied to each of the combustion chambers 104 in an event of a sudden increase in the load on the engine 102. The controller 164 may start an operation of the supercharger system 138 based on the determination that the controller may not sufficiently increase the fuel to the combustion chambers 104 in the event of a transient (i.e. when the engine 102 needs to transition from the low load to meet the sudden increase in the load).

During the operation of the supercharger system 138, the controller 164 may start the supercharger driver 140 to operate the supercharger compressor 144. The supercharger compressor 144 receives a flow of ambient air from the air inlet 142 and pressurizes the received ambient air. Further, the shut off valve 156 is opened to provide a flow of the pressurized air from the compressor outlet 148 to the exhaust manifold 100 of the engine 102, so that the flow of the pressurized air could be provided to the turbine inlet 122 associated with the turbocharger 114. The addition of the compressed air from the supercharger compressor 144 into the exhaust manifold 110 and subsequently to the turbocharger turbine inlet 122 may impart an additional kinetic energy to the turbocharger turbine 116 thereby driving the turbocharger 114 at a speed greater than would be possible without the supercharger 138. Accordingly, the turbocharger turbine 116 may be able to drive the turbocharger compressor 118 at a greater speed to provide a greater intake air pressure in the air intake manifold 106.

As the supercharger system 138 is in continuous operation when the engine 102 is running at low load, there is sufficient air intake pressure in the air intake manifold 106 so that the controller 164 may increase an amount of fuel to be supplied to each of the combustion chambers 104 in an event of the sudden increase in the load on the engine 102. This may enable the engine 102 to have a faster response during the transient condition (i.e. when the engine 102 is transitioning from the low load to meet the sudden application of load on the engine 102). This sudden additional load may be applied on the engine 102 because of a sudden increase in electrical load on the generator 158. In an embodiment, the controller 164 increases the amount of fuel to be supplied to increase the speed of the engine 102 so that the generator 158 may respond to produce frequency and voltage associated with the required electrical load.

Further, the controller 164 may initiate a transition of operating conditions of the engine 102 to accommodate the sudden increase in the electrical load on the generator 158. The controller 164 may determine whether the pressure of the air in the air intake manifold 106 is sufficient to burn enough amount of fuel to meet the sudden additional load applied on the engine 102. The controller 164 may further determine whether the operating conditions of the engine 102 is transitioned to accommodate the sudden increase in the electrical load on the generator 158. Accordingly, the controller 164 may close the shut-off valve 156 and disable the operation of the supercharger system 138.

The controller 164 may also include various software and/or hardware components that are configured to perform functions consistent with the present disclosure. Moreover, the controller 164 may be a standalone control system or may be configured to cooperate with an existing electronic control module (ECM) (not shown) of a machine, for instance, an engine may be located onboard a vehicle, or an engine generator. Furthermore, it may be noted that the controller 164 may embody a single microprocessor or multiple microprocessors that include components for selectively and independently controlling operation of the supercharger compressor 144 and the shut off valve 156 associated with the supercharger system 138.

### INDUSTRIAL APPLICABILITY

The supercharger system 138 may be operated when the engine 102 is operating at a low load, at which the turbocharger 114 alone may not be able to provide the desired intake air pressure for combusting an amount of fuel to meet the sudden additional load, if applied, on the engine 102. The sudden additional load on the engine 102 may be because of a sudden additional electric load on the generator 158 driven by the engine 102.

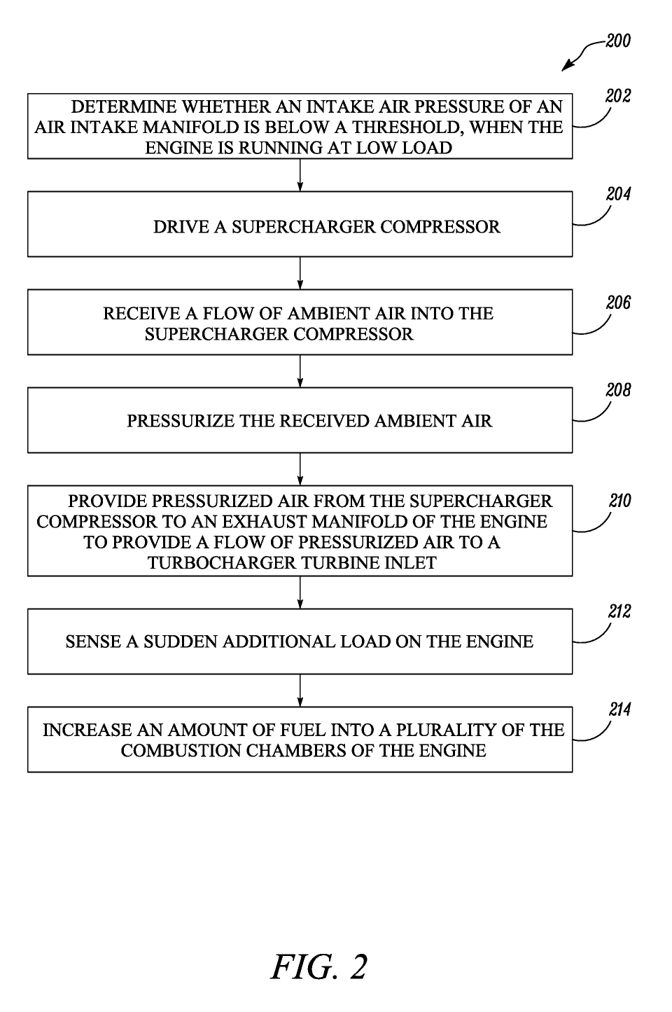

FIG. 2 shows a flowchart of a method 200 for operating the supercharger system 138 of the engine 102. As shown, at step 202, the method 200 includes determining, when the engine 102 is running at a low load, whether an intake air pressure in the air intake manifold 106 or a speed of the turbocharger turbine 116 is below a threshold that may not enable to increase an amount of fuel to be supplied to each of the combustion chambers 104 in an event of a sudden increase in the load on the engine 102. Based on the determination, at step 204, the supercharger driver 140 initiates an operation of the supercharger compressor 144. At step 206, the supercharger compressor 144 receives a flow of ambient air through the air inlet 142. At step 208, the supercharger compressor 144 pressurizes the flow of the received ambient air. At step 210, the shut off valve 156 is opened and the pressurized air form the supercharger compressor 144 is provided to the turbocharger turbine inlet 122 through the exhaust manifold 110 of the engine 102. The flow of the pressurized air from the supercharger compressor 144 provided to the turbine inlet 122 may impart an additional kinetic energy to the turbocharger turbine 116 thereby driving the turbocharger 114 at a speed greater than would be possible without the supercharger 138. Accordingly, the turbocharger turbine 116 may be able to drive the turbocharger compressor 118 at a greater speed to provide a greater intake air pressure in the air intake manifold 106, and thus an increase in the pressurized air supplied to each of the combustion chambers 104.

At step 212, the method 200 includes sensing a sudden additional load on the engine 102. Accordingly, at step 214, the method 200 includes increasing an amount of fuel to be supplied to each of the combustion chambers 104, as there is sufficient amount of pressurized air supplied to each of the combustion chambers 104 to combust the increased amount of fuel. In an embodiment, the increase in the amount of fuel supplied is to increase the speed of the engine 102 so that the generator 158 may respond to produce frequency and voltage associated with the required electrical load. Further, upon determining that the engine 102 is transitioned to accommodate the additional load, the shut off valve is closed 156 and the supercharger system 138 operation is disabled.

Embodiments of the present disclosure have applicability in preventing the engine 102 from lugging or stalling when a surge in the load demand occurs on the engine 102, for instance, when the surge occurs in the amount of the electrical load on the generator 158 that is coupled to the engine 102. Additionally, embodiments of the present disclosure also have applicability for use in continuously developing boost pressure for the intake air at the turbocharger 114 when associated engine 102 is suddenly required to transition from a low load operating condition to a high load operating condition to meet the surge in the load demand. Also, the supercharger system 138 of the present disclosure, provides a simple and compact arrangement resulting in lower space requirement around the engine 102 as compared to usage of storage tanks with the compressed air.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A supercharger system for an engine having a turbocharger, the supercharger system comprising:
a supercharger driver;
an air inlet; and
a supercharger compressor mechanically coupled to the supercharger driver, the supercharger compressor having a supercharger compressor inlet and a supercharger compressor outlet, the supercharger compressor inlet being in fluid communication with the air inlet, and the supercharger compressor outlet being in fluid communication with a turbocharger turbine inlet.

2. The supercharger system of claim 1, wherein the supercharger driver includes one of an electric motor and a hydraulic motor.

3. The supercharger system of claim 1, wherein the supercharger driver includes a mechanical coupling between an engine output and the supercharger compressor.

4. The supercharger system of claim 3, wherein the mechanical coupling includes one of a belt drive system, chain drive system, and a gear drive system.

5. The supercharger system of claim 1, wherein the supercharger compressor outlet is in fluid communication with the turbocharger turbine inlet through an exhaust manifold associated with the engine.

6. The supercharger system of claim 1 further comprising a shut off valve adapted to selectively couple the supercharger compressor outlet with the turbocharger turbine inlet.

7. The supercharger system of claim 6, wherein the shut off valve is configured to open during an operation of the supercharger system.

8. An engine comprising:
a plurality of combustion chambers, each of the plurality of combustion chambers being in fluid communication with an air intake manifold and an exhaust manifold;
a turbocharger including a turbine having a turbine inlet in fluid communication with the exhaust manifold; and
a supercharger system comprising:
a supercharger driver;
an air inlet; and
a supercharger compressor mechanically coupled to the supercharger driver, the supercharger compressor having a supercharger compressor inlet and a supercharger compressor outlet, the supercharger compressor inlet being in fluid communication with the air inlet, and the supercharger compressor outlet being in fluid communication with the turbocharger turbine inlet.

9. The engine of claim 8, wherein the supercharger driver includes one of an electric motor and a hydraulic motor.

10. The engine of claim 8, wherein the supercharger driver includes a mechanical coupling between an engine output and the supercharger compressor.

11. The engine of claim 10, wherein the mechanical coupling includes one of a belt drive system, chain drive system and a gear drive system.

12. The engine of claim 8, wherein the supercharger compressor outlet is in fluid communication with the turbocharger turbine inlet through an exhaust manifold associated with the engine.

13. The engine of claim 8, wherein the supercharger system further comprising a shut off valve adapted to selectively couple the supercharger compressor outlet with the turbocharger turbine inlet.

14. The engine of claim 13, wherein the shut off valve is configured to open during an operation of the supercharger system.

15. A method for operating an engine having a turbocharger and a supercharger, the engine is coupled to a generator, the method comprising:
determining, by means of a controller, whether an intake air pressure of an air intake manifold is below a threshold, when the engine is running at low load,
driving a supercharger compressor,
receiving a flow of ambient air into the supercharger compressor;
pressurizing the received ambient air,
providing pressurized air from the supercharger compressor to an exhaust manifold of the engine to provide a flow of pressurized air to a turbocharger turbine inlet, sensing, by means of a controller, a sudden additional load on the engine, and
increasing an amount of fuel into a plurality of the combustion chambers of the engine.

16. The method of claim 15, wherein providing the pressurized air from the supercharger compressor to the exhaust manifold of the engine comprises opening a shut off valve to provide the pressurized air form the supercharger compressor to the exhaust manifold of the engine.

17. The method of claim 15 further comprises initiation, by means of the controller, a transition of operating conditions of the engine to accommodate the sudden additional load.

18. The method of claim 17 further comprises closing the shut off valve if the operating conditions of the engine is transitioned to accommodate the sudden additional load on the engine.

19. The method of claim 15, wherein the threshold is defined as required intake air pressure in the intake air manifold to enable a supply of an increased amount of fuel in the plurality of combustion chambers during an event of the sudden additional load being applied on the engine.
